(19) United States
(12) Patent Application Publication
(10) Pub. No.: US 2015/0122033 A1
(43) Pub. Date: May 7, 2015

(54) OPTICAL FIBER FOR GENERATING BESSEL BEAM AND OPTICAL IMAGING DEVICE USING SAME

(71) Applicant: POSTECH ACADEMY-INDUSTRY FOUNDATION, Gyeongsangbuk-do (KR)

(72) Inventors: Chulhong Kim, Gyeongsangbuk-do (KR); Kyung Hwan Oh, Seoul (KR); Sung Jo Park, Gyeongsangbuk-do (KR); Jong Ki Kim, Seoul (KR); Sung Rae Lee, Seoul (KR); Man sik Jeon, Daegu (KR); Chang Ho Lee, Daegu (KR)

(21) Appl. No.: 14/503,623

(22) Filed: Oct. 1, 2014

(30) Foreign Application Priority Data
Nov. 5, 2013 (KR) 10-2013-0133761

(51) Int. Cl. G02B 6/32; G01N 21/17

(52) U.S. Cl. CPC G02B 6/32; G01N 21/1702; G01N 2021/1706; G01N 2201/08; G01N 2201/0697; G01N 2201/06113
USPC 73/643; 385/33

(57) ABSTRACT

An optical fiber for generating a Bessel beam and an optical imaging device using the same are disclosed. The optical fiber for generating a Bessel beam includes a single mode optical fiber (SMF) unit, a multi-mode optical fiber unit, and a lens unit. The SMF unit includes a core and a cladding surrounding the core. The multi-mode optical fiber unit comes in contact with a first end of the SMF unit. The lens unit comes in contact with one end of the multi-mode optical fiber unit that faces the first end of the SMF unit.

### BACKGROUND OF THE INVENTION

1. Field of the Invention

The present invention relates generally to an optical fiber for generating a Bessel beam and an optical imaging device using the same and, more particularly, to an optical fiber capable of generating a non-diffractive Bessel beam capable of obtaining a high resolution image and an optical imaging device using the same.

2. Description of the Related Art

A photo-acoustic tomography apparatus is an image processing apparatus using a new method of combining an optical system and an ultrasonic system. When light penetrates into a biological tissue, the biological tissue absorbs the light, and the biological tissue that has absorbed the energy of the light thermoelastically expands. Accordingly, a photo-acoustic (PA) signal having a waveform form is generated. A photo-acoustic tomography apparatus obtains a signal from the generated PA signal using an ultrasonic transducer, and generates a tomographic image by processing the obtained signal.

A conventional optical image processing method may yield a limited image depth or very low spatial resolution because light exhibits a strong scattering effect within a biological tissue. In contrast, a photo-acoustic tomography method is a method of obtaining an image using an acoustic signal generated by a biological tissue that has absorbed the energy of light. In biological tissue, ultrasonic waves scatter much less than light, and thus the photo-acoustic tomography method has an improved image depth compared to the conventional optical image processing method. The spatial resolution of the photo-acoustic tomography apparatus is determined by the center frequency and bandwidth of an ultrasonic transducer for detecting an acoustic signal and the numerical aperture of a lens used in the ultrasonic transducer. As the center frequency of the ultrasonic transducer becomes higher, the spatial resolution may increase. However, obtaining an image in a depth direction may be limited because the scattering of ultrasonic waves in a biological tissue increases.

The photo-acoustic tomography apparatus has recently attracted attention because it can measure an oxygen saturation concentration within blood and the metabolism of a cancer cell using pulse lasers having various waveforms without special contrast media.

A photo-acoustic microscope (PAM) adjusts the focus of light using an object lens in order to make light enter into a biological tissue. If the focal region of the object lens is smaller than that of the ultrasonic transducer, light only in the focal region of the object lens is absorbed by the biological tissue, thereby generating a PA signal. As a result, the side resolution of the biological tissue may further be increased.

In general, a 50 MHz ultrasonic transducer has a resolution of 55 μm in the depth direction and a resolution of 45 μm in the lateral direction, and has a maximum penetration depth of 3 mm. Accordingly, if the size of the spot of the object lens is smaller than 45 μm, a photo-acoustic microscope may have better resolution. The object lens forms a Gaussian-shaped beam. The focal depth of the Gaussian-shaped beam is determined by the waveform of incident light and the function of a focal region. However, the object lens is disadvantageous in that, with respect to light having the same waveform, the focus depth decreases as the focal region decreases. As a result, as lateral resolution increases, the depth to which focused light may penetrate into a biological tissue decreases. Accordingly, a disadvantage arises in that resolution is deteriorated outside the focal region of light.

### SUMMARY OF THE INVENTION

Accordingly, the present invention has been made keeping in mind the above problems occurring in the prior art, and an object of the present invention is to provide an optical fiber that is capable of generating a non-diffractive Bessel beam capable of obtaining a high resolution image.

Another object of the present invention is to provide an optical imaging device using the same that is capable of obtaining a high resolution image.

Effects that may be achieved by the present invention are not limited to the above-described effects, and those skilled in the art to which the present invention pertains will readily appreciate other effects that have not been described from the following description.

In order to achieve one object, the present invention provides an optical fiber for generating a Bessel beam. This optical fiber for generating a Bessel beam may include a single mode optical fiber (SMF) unit configured to include a core and a cladding surrounding the core; a multi-mode optical fiber unit configured to come in contact with a first end of the SMF unit; and a lens unit configured to come in contact with one end of the multi-mode optical fiber unit that faces the first end of the SMF unit.

The difference in a relative refractive index between the core and the cladding may be 1%.

The core may have a diameter of 3.4 μm, and the cladding may have an external diameter of 125 μm. The multi-mode optical fiber unit may have a diameter identical to an external diameter of the cladding.

The multi-mode optical fiber unit may include a coreless silica optical fiber (CSF), and may have a length of about 1,600 μm.

The lens unit may have a curvature radius in the range from 62.5 to 82 μm.

In order to achieve the other object, the present invention provides an optical imaging device. This optical imaging device may use the above-described optical fiber for generating a Bessel beam.

The optical imaging device may include any one of a photo-acoustic tomography apparatus, a photo-acoustic microscope, a photo-acoustic endoscope, a photo-acoustic laparoscope for operation, an optical interference tomography apparatus, a fluorescent imaging apparatus, and a multi-photon microscope using the optical fiber for generating a Bessel beam.

The photo-acoustic microscope may include an optical unit configured to provide light to a second end of the SMF unit; and a detection unit configured to detect ultrasonic waves generated by a sample when a Bessel beam generated by the optical fiber for generating a Bessel beam is incident on the sample.

The optical unit may include a pulse laser configured to generate the light; a beam splitter configured to split the light into two; a photodiode configured to receive a first piece of light and send a trigger signal to the detection unit; and an optical fiber collimator configured to receive a second piece of light and send the second piece of light to the optical fiber for generating a Bessel beam.

The optical unit may further include a collimation lens disposed between the pulse laser and the beam splitter; and a neutral density filter disposed between the beam splitter and the optical fiber collimator.

The detection unit may include an ultrasonic transducer configured to convert the ultrasonic waves generated by the sample into a photo-acoustic signal; and a data processing unit configured to convert the photo-acoustic signal from the ultrasonic transducer into an image.

The optical imaging device may further include an ultrasonic amplifier disposed between the ultrasonic transducer and the data processing unit and configured to amplify the photo-acoustic signal; and a data acquisition unit configured to obtain the amplified photo-acoustic signal and send the obtained photo-acoustic signal to the data processing unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view illustrating an optical fiber for generating a Bessel beam according to an embodiment of the present invention;

FIG. 2 is a cross-sectional view of an image of a Bessel beam generated by the optical fiber for generating a Bessel beam according to an embodiment of the present invention;

FIG. 3 is a diagram illustrating the schematic construction of an optical imaging device using the optical fiber for generating a Bessel beam according to an embodiment of the present invention; and

FIGS. 4A to 4C illustrate images obtained by the optical imaging device using the optical fiber for generating a Bessel beam according to an embodiment of the present invention.

### DESCRIPTION OF THE PREFERRED EMBODIMENTS

Hereinafter, embodiments of the present invention are described in detail with reference to the accompanying drawing. The advantages and characteristics of the present invention and methods for achieving the advantages and characteristics of the present invention will become more apparent from the following embodiments taken in conjunction with the accompanying drawings. However, the present invention is not limited to the disclosed embodiments, but may be implemented in various ways. Rather, the embodiments are provided to make disclosure thorough and complete and sufficiently deliver the spirit of the present invention to those skilled in the art. The same reference numerals designate the same components throughout the specification.

Terms used herein are provided to describe the embodiments, but are not intended to limit the present invention. In the specification, the singular form may include the plural form unless specially described otherwise. Furthermore, terms, such as “comprises” and “comprising,” used herein do not exclude the presence or addition of one or more components, steps, operations, and/or components in the described components, steps, operations, and/or components.

Furthermore, the embodiments described herein may be understood with reference to cross-sectional views, plan views and/or three-dimensional diagrams, that is, ideal exemplary diagrams of the present invention. In the drawings, the thickness of films and regions has been enlarged in order to effectively describe technical features. Accordingly, forms of the exemplary diagrams may be changed by manufacturing technology and/or tolerance. Accordingly, the embodiments of the present invention are limited to the illustrated specific forms, but may include changes in forms generated according to a manufacturing process. For example, a specific region illustrated as being a right angle may be a rounded form or a form having a specific curvature. Accordingly, regions illustrated in the drawings have schematic attributes, and the shapes of the illustrated regions are intended to illustrate a specific form of a region of an apparatus but are not intended to limit the scope of the invention.

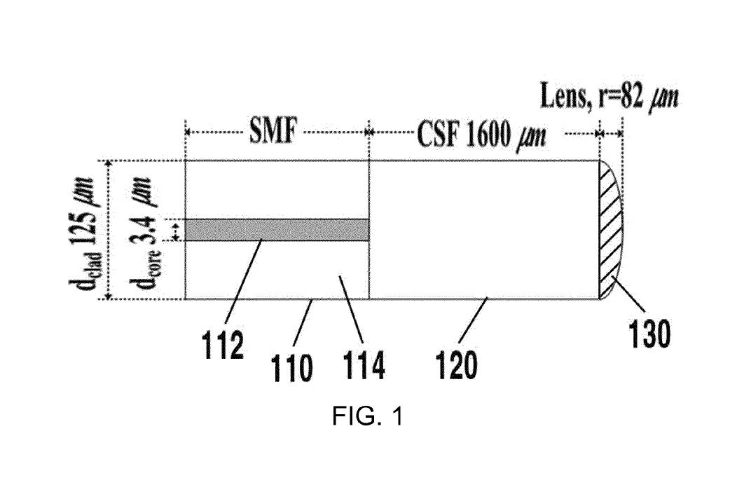

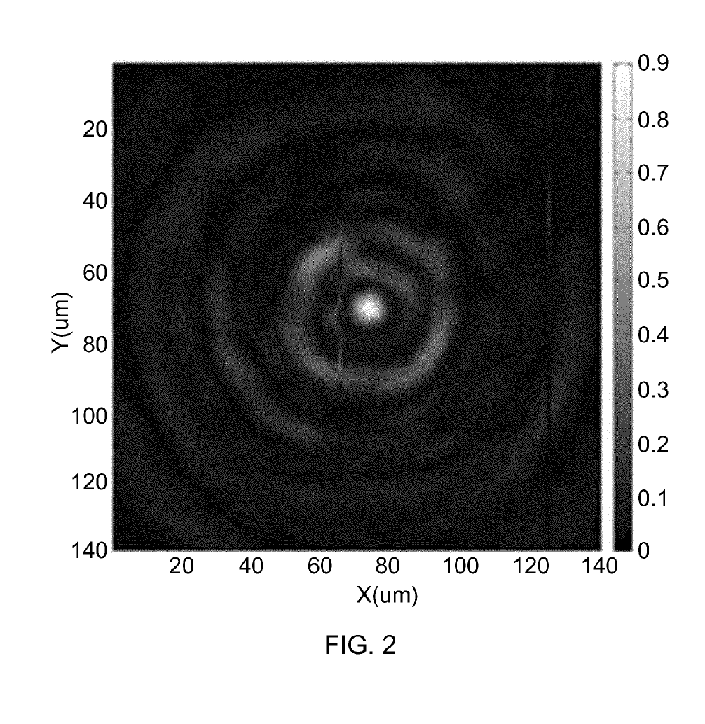

FIG. 1 is a cross-sectional view illustrating an optical fiber for generating a Bessel beam according to an embodiment of the present invention, and FIG. 2 is a cross-sectional view of an image of a Bessel beam generated by the optical fiber for generating a Bessel beam according to an embodiment of the present invention.

Referring to FIG. 1, the optical fiber for generating a Bessel beam includes a single mode optical fiber (SMF) unit 110, a multi-mode optical fiber unit 120, and a lens unit 130.

The SMF unit 110 may include a core 112, and a cladding 114 surrounding the core 112. In general, the SMF unit 110 may be a commercial optical fiber having the model name “HI1060FLEX.” The core 112 may have a diameter of 3.4 μm, and the cladding 114 may have an external diameter of 125 μm. The difference in the relative refractive index between the core 112 and the cladding 114 may be 1%.

The multi-mode optical fiber unit 120 may come in contact with one end of the SMF unit 110. When heat is applied to a contact surface between the two optical fiber units 110 and 120 using equipment for connecting optical fibers in the state in which force has been applied to the multi-mode optical fiber unit 120 in the direction of one end of the SMF unit 110, the two optical fiber units 110 and 120 are connected to each other. The multi-mode optical fiber unit 120 may be a coreless silica optical fiber (CSF) having no core. The length of the multi-mode optical fiber unit 120 may be about 1,600 μm. The multi-mode optical fiber unit 120 may have the same external diameter as the cladding 114 of the SMF unit 110.

The lens unit 130 may come in contact with one end of the multi-mode optical fiber unit 120 that faces one end of the SMF unit 110. The lens unit 130 may have a curvature radius in a range from 62.5 to 82 μm. The lens unit 130 may be fabricated using two types of methods.

The lens unit 130 fabricated using one of the two methods may include polymer. That is, the lens unit 130 may be formed by placing liquid polymer on one end of the multi-mode optical fiber unit 120 and then hardening the liquid polymer. The surface of the liquid polymer has a curvature by self-surface tension, and the curvature of the liquid polymer may be controlled by controlling the amount of liquid polymer.

The lens unit 130 fabricated using the other of the two methods may be formed in such a manner that one end of the multi-mode optical fiber unit 120 has a lens form by applying heat to one end of the multi-mode optical fiber unit 120. In this case, the curvature of the lens unit 130 may be controlled by the temperature of heat applied to one end of the multi-mode optical fiber unit 120 and the time during which heat is applied.

Referring to FIGS. 1 and 2, light incident on the SMF unit 110 propagates in single mode, passes through the SMF unit 110, and is incident on the multi-mode optical fiber unit 120. Accordingly, a Bessel beam is generated by the multi-mode interference phenomenon of the multi-mode optical fiber unit 120 having no core. The generated Bessel beam may maintain a multi-mode interference pattern having no diffraction in the direction in which light propagates by means of the lens unit 130. As a result, the focus distance of the Bessel beam may increase.

Such a Bessel beam has a size that is smaller than a Gaussian beam, and also has a focus depth that is several hundreds of times longer than the focus depth of the Gaussian beam, thereby being capable of obtaining a deeper image having a high sample resolution.

The optical fiber for generating a Bessel beam according to an embodiment of the present invention can overcome the limitation of a focus depth in an object lens having a high numerical aperture because it has a simple structure and generates a non-diffractive Bessel beam, and can also obtain a high resolution image because it has a small beam spot size of 10 μm or less. Accordingly, the optical fiber for generating a Bessel beam, which is capable of obtaining a high resolution image at low cost, can be provided.

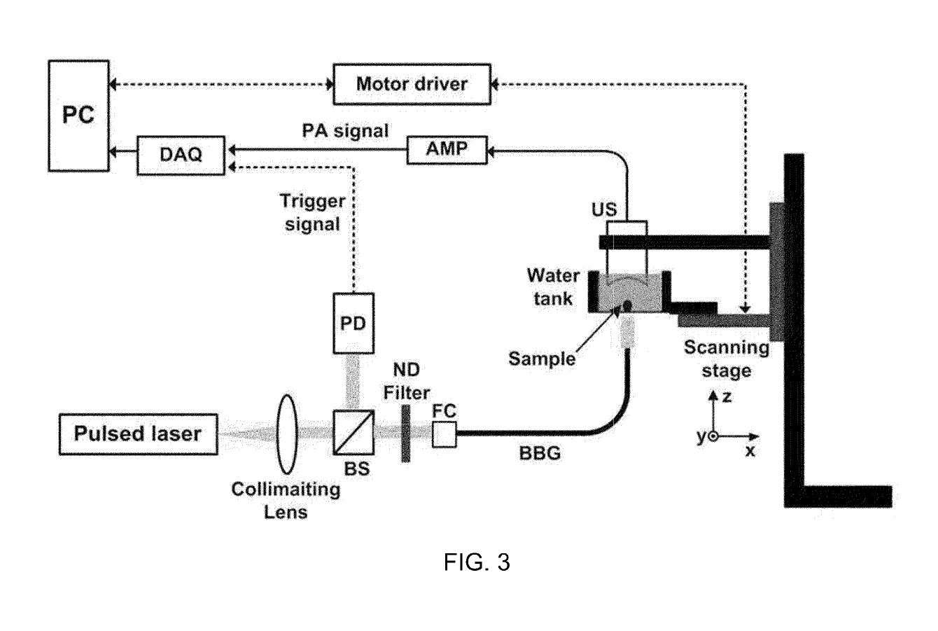

FIG. 3 is a diagram illustrating the schematic construction of an optical imaging device using the optical fiber for generating a Bessel beam according to an embodiment of the present invention. FIG. 3 illustrates an example in which an optical resolution-PAM (OR-PAM) using the optical fiber for generating a Bessel beam according to an embodiment of the present invention is used as an example. An optical imaging device according to an embodiment of the present invention is not limited to that of FIG. 3, but may include a photo-acoustic tomography apparatus, a photo-acoustic endoscope, a photo-acoustic laparoscope for operation, an optical interference tomography apparatus, a fluorescent imaging apparatus, or a multi-photon microscope.

Referring to FIG. 3, the OR-PAM may be a focus-free OR-PAM. Hereinafter the OR-PAM is referred to as the PAM.

The PAM may include an optical unit, the optical fiber for generating a Bessel beam BBG (refer to FIG. 1), and a detection unit. The optical unit may provide light to the other end of the SMF unit (refer to 110 of FIG. 1) of the optical fiber for generating a Bessel beam BBG. The detection unit may detect ultrasonic waves generated by a sample when a Bessel beam generated by the optical fiber for generating a Bessel beam BBG is incident on the sample.

The optical unit may include a pulse laser configured to generate light; a beam splitter (BS) configured to split light from the pulse laser into two; a photodiode (PD) configured to receive one piece of light and send a trigger signal to the detection unit; and an optical fiber collimator (FC) configured to receive the other piece of light and send the other piece of light to the optical fiber for generating a Bessel beam BBG. The optical unit may include a collimation lens disposed between the pulse laser and the BS; and a neutral density (ND) filter disposed between the BS and the optical FC.

The detection unit may include an ultrasonic transducer (US) configured to convert ultrasonic waves, generated by the sample, into a photo-acoustic (PA) signal; and a data processing unit (PC) configured to convert the PA signal from the US into an image. The PC may function to control the operation of a PAM. That is, the PC may be a computer capable of performing many functions, such as the arithmetic ability and the display ability for various signals, at the same time. The detection unit may further include an ultrasonic amplifier (AMP) disposed between the US and the PC and configured to amplify the PA signal; and a data acquisition (DAQ) unit configured to obtain the amplified PA signal and send the amplified PA signal to the PC.

The PAM may include a driving unit. The PC may issue a driving instruction to the driving unit based on an operation signal transmitted from the PD of the optical unit to the PD through the DAQ unit of the detection unit. The driving instruction may control a motor driver so that it moves in the 3-axis direction of a scanning stage. Accordingly, a three-dimensional (3-D) image of the sample may be obtained. In order for ultrasonic waves to be easily detected, the sample may be immersed in water within a water tank.

The operation of the PAM is described in brief below. Light emitted from the pulse laser may be collimated by the collimation lens. The BS may split the collimated light into first light that enters the PD and second light that enters the optical FC. The first light incident on the PD may be used as an operation signal for signal processing in the PC. The second light incident on the optical FC may propagate through the optical fiber for generating a Bessel beam BBG, and thus a non-diffractive Bessel beam may be generated at the end of the optical fiber for generating a Bessel beam BBG. The generated non-diffractive Bessel beam may be incident on the sample. The sample that has absorbed the non-diffractive Bessel beam may generate ultrasonic waves. The US may convert the generated ultrasonic waves into a PA signal. The converted PA signal may be converted into an image through the PC. Accordingly, a two-dimensional (2-D) or a 3-D image or both of the sample may be obtained.

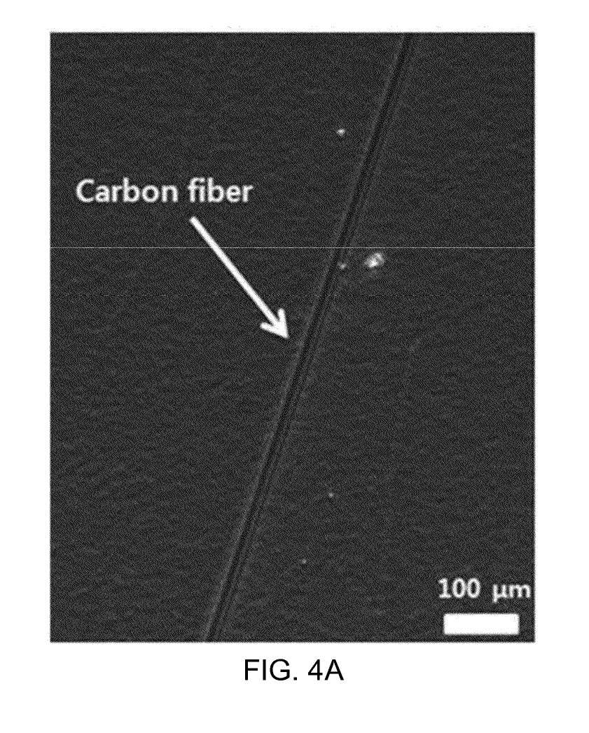

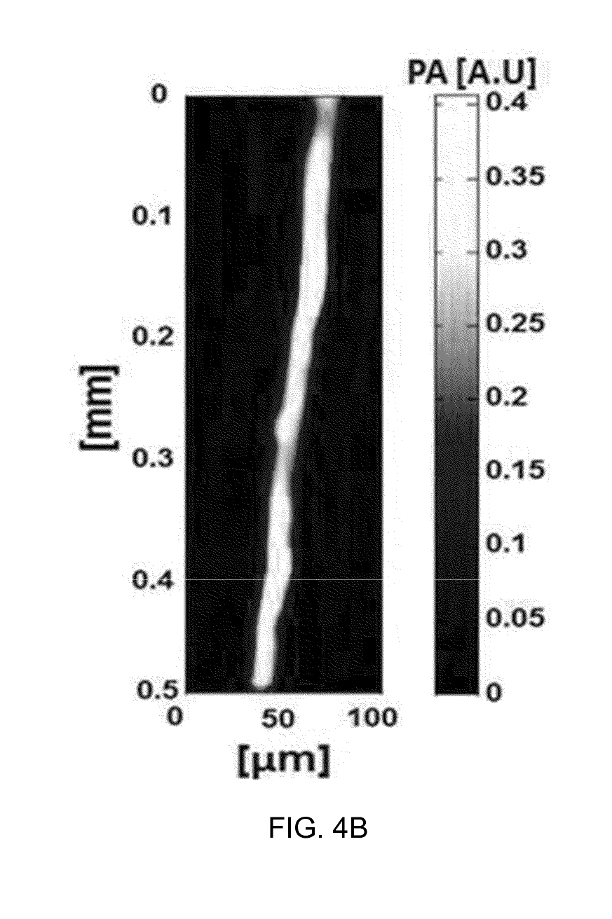

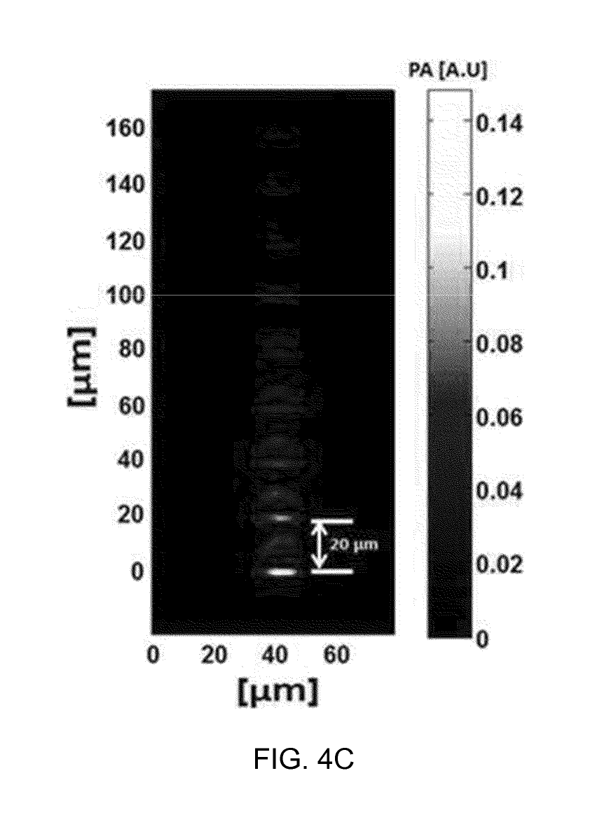

FIGS. 4A to 4C illustrate images obtained by the optical imaging device using the optical fiber for generating a Bessel beam according to an embodiment of the present invention.

FIG. 4A illustrates an image of a carbon fiber sample having a diameter of 6.8 μm that was obtained using a PAM using an object lens, and FIGS. 4B and 4C illustrate images of the carbon fiber sample that were obtained using the PAM using the optical fiber for generating a Bessel beam according to an embodiment of the present invention.

It may be seen that the image of FIG. 4B has resolution higher than that of FIG. 4A. FIG. 4C is a cross-sectional image of the sample that was measured by increasing the distance between the optical fiber for generating a Bessel beam and the sample by 20 μm. From FIG. 4C, it can be seen that the width of the sample is regular to some extent.

As described above, since the optical imaging device according to an embodiment of the present invention includes the optical fiber for generating a Bessel beam, alignment for guiding light to a sample is not necessary, and a measurement probe is flexible and may have a small size. Accordingly, a high resolution image can be obtained at low cost, and the optical imaging device having a small size and various forms can be provided.

Furthermore, the limitation of a focus depth in an object lens having a high numerical aperture can be overcome because a non-diffractive Bessel beam is generated using the optical fiber having a simple structure, and a high resolution image can be obtained because a beam spot has a small size of 10 μm or less. Accordingly, the optical fiber for generating a Bessel beam that is capable of obtaining a high resolution image at low cost can be provided.

The embodiments of the present invention have been described with reference to the accompanying drawings, but those skilled in the art to which the present invention pertains will understand that the present invention may be implemented in various detailed forms without changing the technical spirit or indispensable characteristics of the present invention. It will be understood that the aforementioned embodiments are illustrative, but are not limitative from all aspects.

What is claimed is:

1. An optical fiber for generating a Bessel beam, comprising:
a single mode optical fiber (SMF) unit configured to include a core and a cladding surrounding the core;
a multi-mode optical fiber unit configured to come in contact with a first end of the SMF unit; and
a lens unit configured to come in contact with one end of the multi-mode optical fiber unit that faces the first end of the SMF unit.

2. The optical fiber of claim 1, wherein a difference in a relative refractive index between the core and the cladding is 1%.

3. The optical fiber of claim 1, wherein:
the core has a diameter of 3.4 μm; and
the cladding has an external diameter of 125 μm.

4. The optical fiber of claim 3, wherein the multi-mode optical fiber unit has a diameter identical to an external diameter of the cladding.

5. The optical fiber of claim 1, wherein the multi-mode optical fiber unit comprises a coreless silica optical fiber (CSF).

6. The optical fiber of claim 1, wherein the lens unit has a curvature radius in a range from 62.5 to 82 μm.

7. An optical imaging device using an optical fiber for generating a Bessel beam according to claim 1.

8. The optical imaging device of claim 7, wherein the optical imaging device comprises any one of a photo-acoustic tomography apparatus, a photo-acoustic microscope, a photo-acoustic endoscope, a photo-acoustic laparoscope for operation, an optical interference tomography apparatus, a fluorescent imaging apparatus, and a multi-photon microscope using the optical fiber for generating a Bessel beam.

9. The optical imaging device of claim 8, wherein the photo-acoustic microscope comprises:
an optical unit configured to provide light to a second end of the SMF unit; and
a detection unit configured to detect ultrasonic waves generated by a sample when a Bessel beam generated by the optical fiber for generating a Bessel beam is incident on the sample.

10. The optical imaging device of claim 9, wherein the optical unit comprises:
a pulse laser configured to generate the light;
a beam splitter configured to split the light into two;
a photodiode configured to receive a first piece of light and send a trigger signal to the detection unit; and
an optical fiber collimator configured to receive a second piece of light and send the second piece of light to the optical fiber for generating a Bessel beam.

11. The optical imaging device of claim 10, wherein the optical unit further comprises:
a collimation lens disposed between the pulse laser and the beam splitter; and
a neutral density filter disposed between the beam splitter and the optical fiber collimator.

12. The optical imaging device of claim 9, wherein the detection unit comprises:
an ultrasonic transducer configured to convert the ultrasonic waves generated by the sample into a photo-acoustic signal; and
a data processing unit configured to convert the photo-acoustic signal from the ultrasonic transducer into an image.

13. The optical imaging device of claim 12, further comprising:
an ultrasonic amplifier disposed between the ultrasonic transducer and the data processing unit and configured to amplify the photo-acoustic signal; and
a data acquisition unit configured to obtain the amplified photo-acoustic signal and send the obtained photo-acoustic signal to the data processing unit.
